(19) United States
(12) Patent Application Publication
(10) Pub. No.: US 2007/0088848 A1
(43) Pub. Date: Apr. 19, 2007

(54) Method for limiting the number of times to forward a multimedia message in MMSC

(76) Inventors: Kehua Chen, Shenzhen (CN); Guangehang Bai, Shenzhen (CN); Dawei Li, Shenzhen (CN); Weinning Cheng, Shenzhen (CN)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/473,664

(22) Filed: Jun. 23, 2006

(30) Foreign Application Priority Data
Jun. 27, 2005 (CN) 10079988.6

(51) Int. Cl. G06F 15/173

(52) U.S. Cl. 709/238

(57) ABSTRACT

The present invention provides a method that restricts the number of times that a multimedia message can be forwarded among several multimedia messaging service centers (MMSCs). When the originator MMSC forwards a multimedia message to the next MMSC, the MMSC adds a new field: a forward counter, in the message and assigns an initial value to the field. Then, the modified message is sent out to the next MMSC in the MM4 protocol. If the recipient terminal of the message belongs to the current MMSC, the current MMSC simply delivers the message to the recipient in the MM1 protocol and the process is completed. Otherwise, the multimedia message will be forwarded to the next MMSC with the forward counter incremented by one until either the right MMSC receives the message or the forward counter reaches the predefined maximum number. Then MMSC process the message according other rule.

### CROSS-REFERENCE TO RELATED APPLICATIONS

This application claims priority from Chinese Application No. 200510079988.6, filed Jun. 27, 2005.

1. Field of the Technology

This invention relates to message handling technology for a multimedia messaging service (MMS) system. In particular, this invention relates to a method which can restrict the number of times that a multimedia message can be forwarded in a multimedia messaging service center (MMSC).

2. Background of the Invention

A multimedia messaging service (MMS) is a further development of a short messaging service (SMS) and an enhanced messaging service (EMS). An MMS provides a completed end-to-end solution for personal multimedia mobile communication services. In view of the contents of communications, a multimedia message consists of pictures, audio, video and data. In view of the capabilities, it covers various types of multimedia communications including terminal-to-terminal, terminal-to-application server, and application server-to-terminal. Thus the multimedia messaging services not only accomplishes message exchanges among the terminals, between the terminal and the application server, also combines multiple contents such as picture, voice, video, data and/or text.

Used as an open interface for media, an MMS system can provide various rich content services via interactions between a mobile user and an internet content provider. A user is not only an MMS customer, but also can be an MMS content developer. Doubtlessly, this will increase the interests for end users' services in the multimedia marketplace.

FIG. 1 depicts the current MMS system configuration. As shown in FIG. 1, MMS system includes various network types, such as 2G mobile networks, 3G mobile networks, internets, etc. The network interface is accommodated via internet protocols as well as other related network message protocols. In addition, the multimedia messages transfer protocols on the 2G/3G mobile network can be compatible with the existing multimedia message transfer protocols on the internet. The main elements in an MMS system shown in FIG. 1 are described as follows:

At the terminal side, an MMS User Agent: an MMS User Agent (MMS UA) is installed in the MMS terminal to provide multimedia messaging services. An MMS User Agent is one of applications on the user terminal, which provides capabilities for viewing, editing, handling multimedia messages. It can send, receive and delete multimedia messages. An MMS User Agent can support the Multipurpose Internet Mail Extensions (MIME) protocols. Multimedia messages are represented in the MIME format. Based on various type fields, a multimedia message may contain text, picture, audio and/or video information.

A Wired Email Client: a wired email client is used to communicate with the MMS systems via email, e.g., an email flow from a terminal or to a terminal.

At the network side, the MMS system contains primarily a Multimedia Messaging Service Environment (MMSE). An MMSE is a complete and independent group that combines various network elements. It includes as follows.

1. An MMS Relay/Server: an MMS relay/server performs the protocol transformation, content arrangement, storing and dispatching for a multimedia message among different multimedia equipment. It can also generate charging details.

2. An MMS User Databases: the MMS user databases are used to store customer information, personal profile, interface properties. For examples, it may have the capabilities profile for a mobile terminal, or the subscription information of a user, the home location register (HLR) information of a user.

3. A Message Store: a message store is used to store multimedia information of a user. Due to usually large size of multimedia information and the limited storage space in a user terminal, a user can store information in a message store, such as the dream network album in China Mobile Co.

The MMS relay/servers, the MMS user databases and the message stores form the core entities of an MMS system, i.e., a multimedia messaging service center (MMSC).

4. An MMS External Value Added Service Application (VAS Application): an MMS VAS Application usually abbreviated as SP/CP, belongs to a value added service provider (VASP) that provides various value added services for multimedia messaging services.

5. An External Server: an external server provides other services that are related to the multimedia messaging services, such as a prepaid platform, data service management platform, etc.

A service provider needs to have several MMSCs to separately provide a service to customers when a service is actually offered. Each MMSC manages part of customers and provides access capabilities only for those customers.

FIG. 2 depicts various network elements in an MMS system that has multiple MMSCs interconnected. As shown in FIG. 2, an MMSC is communicated with the user terminal through a WAP gateway via the MM1 protocol. An MMSC is communicated with an Email Server in an IP Network via the MM3 protocol and emails are carried via the Simple Mail Transfer Protocol (SMTP). An MMSC and a SP/CP are communicated via the MM7 protocols and their messages are carried via the Hypertext Transfer Protocol (HTTP) or other protocols. An MMSC is communicated with other MMSCs via the MM4 protocol and their messages are carried via SMTP protocols. Sending a multimedia message also needs an Enum Server to process the E.164 address for analyzing the domain name. The Enum Server can examine the recipient's terminal number to determine a proper routing. It informs the MMSC whether a message needs to be forwarded or not. If so, it indicates which MMSC the message should be forwarded to.

The message exchanges are done via the MM4 interface protocol among multiple MMSCs. FIG. 3 shows a message exchange sequence for multimedia messages using the existing MM4 interface protocol. As shown in FIG. 3, at the originator MMSC, upon receiving a submit request (MM1_submit.Req) from an originator MMS UA, the originator MMS relay/server finds out the forwarding route from the Enum Server, then forwards the multimedia message plus its relevant property information via the MM4_forward.REQ message. Here, the word “forward” is the same as “resend” or “retransmit”. After forwarding through several MMSCs, the message is received by the recipient MMSC. The recipient MMS relay/server then delivers the multimedia message to the recipient user terminal and also responds to the originator MMSC with the MM4_forward.RES message. When the recipient MMSC receives the received acknowledgement (MM1_acknowlegement.REQ) from the recipient terminal, it sends back the MM4_delivery_report.REQ message to the originator MMSC. Upon receiving this message, the originator MMSC responds the recipient MMSC with an MM4_delivery_report.RES and also sends the MM1_delivery_report.REQ to the originator terminal. When the recipient MMSC receives the MM1_read_reply_recipent.REQ from the recipient terminal, it sends the MM4_read_reply_report.REQ message to the originator MMSC. Upon receiving this message, the originator MMSC responds the MM4_read_reply_report.RES to the recipient MMSC and also sends the MM1_read_reply_originator.REQ message to the originator terminal.

In this procedure, if the originator MMSC and the recipient MMSC are not the same MMSC, the originator MMSC needs to retransmit the messages in the MM4 protocol to other MMSC. However, in the existing procedure, there is no scheme to restrict the number of times of retransmitting a multimedia message among several MMSCs. During researching the present invention, inventor discovered a technical problem that isn't be known by any others hid in foregoing prior art, the question is:

If the static routing tables are adapted in these interconnected MMSCs, it may cause a multimedia message is retransmitted back and forth infinitely among two or more MMSCs when their routing tables are incorrectly arranged. This retransmission can occupy a lot of system resources in the MMSC and waste resources undetected.

### SUMMARY OF THE INVENTION

The present invention proposes the following method.

A method of handling a multimedia message in an MMSC so that the number of times of a multimedia message can be forwarded to other MMSC is limited. This method comprises:

Procedure A: when the originator MMSC forwards a multimedia message to the next MMSC, the originator MMSC adds a new forward counter field and assigns the field an initial value before forwarding. The next MMSC is then treated as the current MMSC and Procedure B is executed.

Procedure B: when the current MMSC receives a multimedia message from the previous MMSC, the current MMSC analyzes the forward counter field and, according to the value of the field, determines whether the number of times on forwarding is over the limit. If so, the current MMSC stops processing that message and this procedure is completed. Otherwise, the current MMSC updates the value in the forward counter field according a predefined rule and sent the modified message to the next MMSC. The next MMSC is then treated as the current MMSC and Procedure B is repeated.

In Procedure A, prior to the originator MMSC forwarding a multimedia message to the next MMSC, the originator MMSC needs to determine whether the recipient terminal belongs to the same MMSC. If so, the originator MMSC simply delivers the message to its recipient terminal and the Procedure A is completed. Otherwise, it continues the rest of Procedure A.

In Procedure B, prior to the current MMSC analyzes the forward counter field of a multimedia message received, the current MMSC needs to determine whether the recipient terminal belongs to the current MMSC. If so, the current MMSC simply delivers the message received to the recipient terminal in the same MMSC and Procedure B is completed. Otherwise, the current MMSC continues processing the rest of Procedure B.

In Procedure B, when the current MMSC analyzes the forward counter field in the multimedia message received, it needs first to determine whether the message has a forward counter field. If so, it continues processing the rest of Procedure B. Otherwise, it adds a new forward counter field and assigns an initial value to the field, then forward the modified message to the next MMSC. The next MMSC is then treated as the current MMSC and Procedure B is repeated.

In Procedure B, when the current MMSC retrieves the value of the forward counter field, the current MMSC needs to determine whether the value is a valid value. If so, it continues processing the rest of Procedure B. Otherwise (the value is invalid, i.e., the value is less than or equal to 0), the current MMSC resets its value to an initial value in the forward counter, then continues the rest of Procedure B.

In Procedure B, after the current MMSC determines that the number of times on forwarding is not over the limit and prior to the current MMSC sends the modified message to the next MMSC, the current MMSC needs to determine whether the recipient terminal belongs to the current MMSC. If so, the current MMSC simply delivers the message to the recipient terminal in the MMSC and Procedure B is completed. Otherwise, continue to process the rest of Procedure B.

The forwarding message sent by an MMSC is the multimedia forward request in the MM4 protocol (MM4_forward.REQ). The new field added in this message is a forward counter field.

In Procedure B, a predefined rule may be in an increasing order, in a decreasing order or in any other manner. If an increasing order is adapted, then the initial value in the forward counter field is set to 1. Each time the message is forwarded, the counter is increased by 1. And the MMSC stops forwarding the message when this counter reaches the limit of allowable number of forwarding. If a decreasing order is adapted, then the initial value in the forward counter field is set to the maximum number of forwarding allowed. Each time the message is forwarded, the counter is decreased by 1. And the MMSC stops forwarding a message when this counter reaches 1. There are other rules which can be used, as long as the number of times of forwarding can be derived from those rules.

In the present invention, the new forward counter field is added in the forward request message in the MM4 protocol by the MMSC. Each time the forward request message is forwarded, the forward counter field is updated to keep track the number of times that a message has been forwarded. If the number exceeds the allowable limit of forwarding, the MMSC stops forwarding that message. This method can restrict the number of time that a multimedia message can be forwarded among several MMSCs, thus the method can avoid a message is forwarded in cycling infinitely and waste resources in an MMS systems. Furthermore, an administrator of MMS system may detect routing errors by tracing values of forward counters and the relevant MMSCs. Thus, the invention may also help resolving the routing trouble.

### BRIEF DESCRIPTION OF THE DRAWINGS

FIG. 1 illustrates the main elements in an existing MMS system architecture;

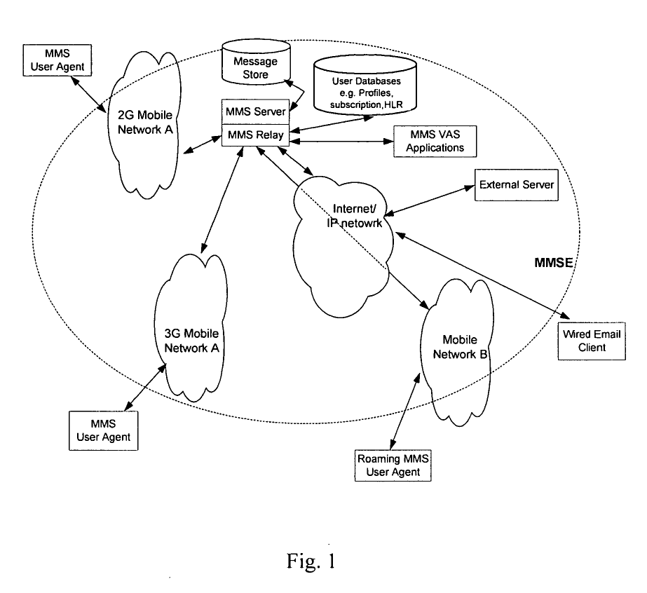

FIG. 2 illustrates an MMS system network configuration that multiple MMSCs are interconnected via various protocol interfaces;

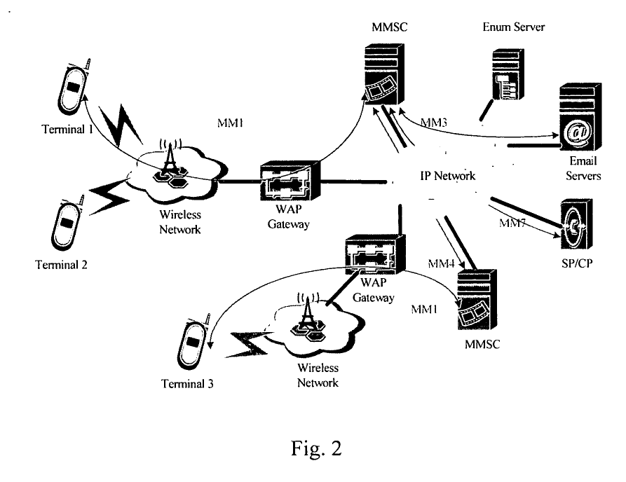

FIG. 3 illustrates the message flow sequences for handling a multimedia message via an MM4 interface protocol;

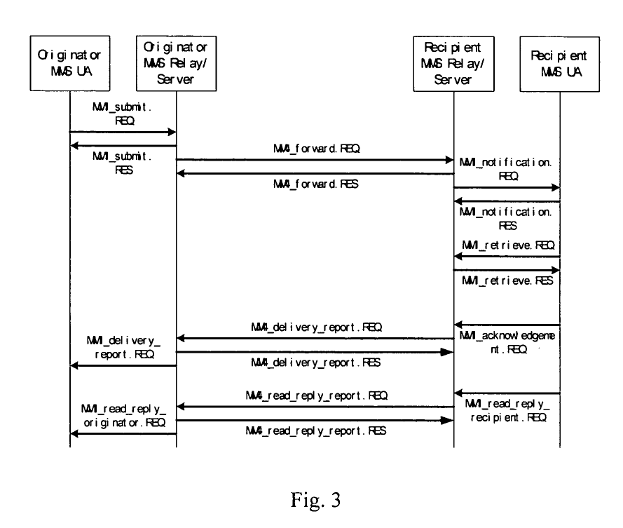

FIG. 4 illustrates a flow diagram for the originator MMSC handling and delivering a multimedia message; and

FIG. 5 illustrates a flow diagram for the relay MMSC or the recipient MMSC handling and delivering a multimedia message.

### DETAILED DESCRIPTION OF THE INVENTION

With reference to the figures, embodiments of the present invention are illustrated as follows.

In this embodiment, as an example for illustration, an MMSC receives a multimedia message from an originator user terminal. This multimedia message is retransmitted by one or more relay MMSCs and eventually reaches the recipient MMSC.

Upon receiving a multimedia message, the current MMSC first determine the sender. If that message is an MM1 message from a user terminal, the current MMSC is the originator MMSC of that message. Thus, the current MMSC conducts the delivery procedures as the originator MMSC. If that message is a forwarding MM4 message from other MMSC, then the current MMSC is either a relay or a recipient MMSC. Thus, the current MMSC conducts the relay or receiving procedures.

The above mentioned MM1 message is a message sent from a user terminal to an MMSC in an MM1 protocol, such as a multimedia submit request message (MM1_submit.REQ), a multimedia notification response message (MM1_notification.RES), a multimedia retrieve request message (MM1_retrieve.REQ), a multimedia acknowledgement request (MM1_acknowledgement.REQ), and a multimedia read reply from recipient request message (MM1_read_reply_recipient.REQ). The above mentioned MM4 messages are messages transmitted between MMSCs, such as a multimedia forward request message (MM4_forward.REQ), a multimedia forward response message (MM4_forward.RES), a multimedia delivery report request (MM4_delivery_report.REQ), a multimedia delivery report response message (MM4_delivery_report.RES), a multimedia read reply report request message (MM4_read_reply_report.REQ), and a multimedia read reply report response message (MM4_read_reply_report.RES).

The following example illustrates the situation that an MMSC receives an MM1_submit.REQ message and sends an MM4_forward.REQ message to another MMSC.

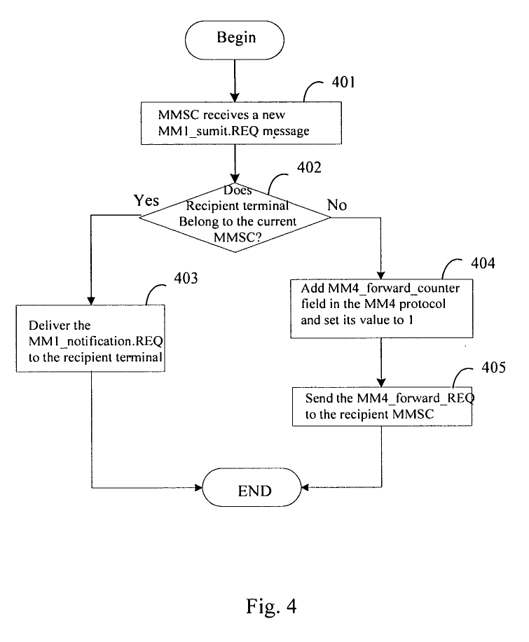

FIG. 4 depicts a flow chart for an originator MMSC handling and submitting a multimedia message. As shown in FIG. 4, it includes:

Step 401: the originator MMSC receives a multimedia message in the MM1 protocol from an originator terminal. In this example, an MM1_submit.REQ is received, which contains a multimedia information and recipient terminal information.

Steps 402 and 403: the Enum Server in the originator MMSC looks up the required routing according to the recipient terminal address in the MM1 message received. Based on the routing result, the Enum Server determines whether the recipient user terminal belongs to the same MMSC. If so, it sends the MM1 message directly to the recipient terminal and completes the process. In this embodiment, the MMSC receives an MM1_submit.REQ, thus MMSC sends an MM1 multimedia notification request message (MM1_notification.REQ) to recipient terminal to ask the recipient obtaining the multimedia information at the same MMSC. If the MMSC receives an MM1_acknowledgement.REQ message, then the MMSC sends an MM1 delivery report request message (MM1_delivery_report.REQ) to the originator user terminal. If the MMSC receives an MM1_read_reply_recipient.REQ message, then the MMSC sends the corresponding MM1 read replay message to the originator terminal (MM1_read_reply_originator.REQ).

If the recipient user terminal does not belong to the same MMSC, the current MMSC need to convert the content of the MM1 message to an MM4 message and send it to the recipient MMSC (Step 404). In this embodiment, the MM1_submit.RQ message is converted to the MM4_forward.REQ message before being sent out.

Step 404: the originator MMSC adds a forward counter field in the MM4 message, i.e., the MM4_forward_counter field, and sets its value to 1. This counter is used to keep track the number of times that the multimedia message has been forwarded.

Step 405: according to the routing results from Step 402, the current MMSC forwards the modified MM4 message to the next MMSC.

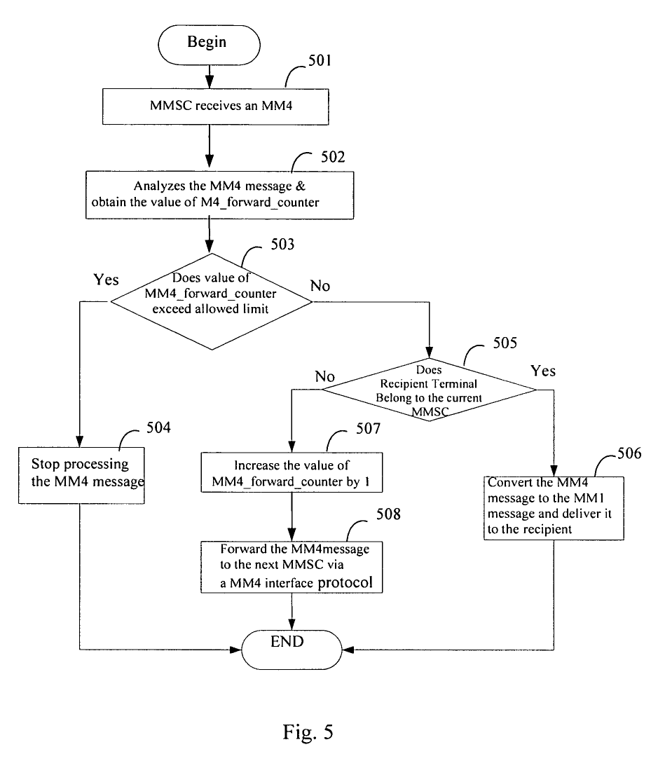

FIG. 5 illustrates a flow diagram for a relay/recipient MMSC handling and delivering a multimedia message. As shown in FIG. 5, it includes the following Steps.

Step 501: the current MMSC receives an MM4 message from another MMSC. In this embodiment, the receiving message is an MM4_forward.REQ message.

Step 502: the MMSC analyzes the MM4 message and obtains the value of the forward counter.

If the received MM4 message comes from an MMSC that does not support the forward counter feature, then the message does not have the forward counter field. In this case, Step 502 needs to first determine whether the MM4 message contains a forward counter field. If so, it analyzes the value, otherwise the current MMSC adds a forward counter field in the received MM4 message and sets the value to 1.

In the usually case, the value of forward counter can not be less than 0. However, to avoid another MMSC incorrectly entering value less than or equal to 0, this embodiment of the invention may add another step before Steps 503 and 504, the new step can determine whether the forward counter is less than or equal to 0. If so, the new step re-sets the value of the forward counter to 1, then proceeds with Steps 503 and 504; otherwise, proceeds directly with Steps 503 and 504.

Steps 503 & 504: the current MMSC determines whether the value of the forward counter exceeds the predefined maximum number of forwards allowed. If so, the MMSC terminates the process of the MM4 message, otherwise continue with Step 505.

Step 505 & 506: the Enum Server in the current MMSC finds the routing based on the recipient terminal's address information in the MM4 message received. The current MMSC determines whether the recipient terminal belongs to the same MMSC based on the result of routing inquiry. If so, the MMSC needs not forward the MM4 message, instead it delivers the corresponding MM1 message directly to the recipient user terminal. In this embodiment, the MM4_forward.REQ is received, thus the corresponding MM1 message is the multimedia notification request message (MM1_notification.REQ) that is sent to the recipient terminal to obtain the multimedia information in the current MMSC. The process is done.

If the recipient terminal does not belong to the current MMSC, the MMSC performs Step 507.

Step 507: Increases the value of MM4_forward_counter by 1 in the MM4_forward.REQ message.

In this embodiment, the value of MM4_forward_counter is increased by 1 to keep track the number of times that a multimedia message has been forwarded by the MMSC. Obviously, we may choose to decrease the value of MM4_forward_counter by 1 if the counter is initially set to the maximum number allowed for forwards. If the value becomes 1, the MMSC stops forwarding the message. Also, we may use other rule to update the value of MM4_forward_counter, as long as we can determine the number of times that a message has been forwarded.

Step 508: According the routing results from Step 505, the current MMSC sends the updated MM4_forward.REQ message to the next MMSC.

In this flow diagram, we can perform Step 505 after completing Step 501. If the recipient terminal belongs to the same MMSC, then perform Step 506. If the recipient terminal does not belong to the same MMSC, then perform Step 502 and the rest of steps. And when Step 503 is executed, if the value of MM4_forward_counter does not exceed the maximum allowed value for forwarding a message, we continue with Step 507 and the rest of Steps. In this manner, we can also accomplish the same goal for this invention.

The above description is one of the preferred embodiments for this invention and the accompanying figures are only intended to illustrate this invention as an example. Various changes and modifications on the above method are possible and are within the scope of this invention.

1. A method for restricting the number of times of forwarding a multimedia message by a multimedia messaging service center (MMSC), comprising the steps of:
a first MMSC, an originator of a multimedia message, adding a forward counter field to the multimedia message and assigning an initial value to the forward counter field;
the first MMSC forwarding the multimedia message to a second MMSC;
treating the second MMSC as a current MMSC and executing following steps;
the current MMSC analyzing the multimedia message and checking the value of the forward counter field; if the value of the forward counter field reaches a predefined value, not forwarding the multimedia message and exiting the forwarding steps.

2. The method as claimed in claim 1, wherein prior to the first MMSC initializing the forward counter field, further comprising the steps of:
the first MMSC determining whether a recipient user terminal for the multimedia message belongs to the same MMSC;
if so, the first MMSC delivering the multimedia message directly to the recipient user terminal and exiting the forwarding process; otherwise, continuing with the forwarding process.

3. The method as claimed in claim 1, further comprising:
if the value of the forward counter field do not reach a predefined value:
updating the value of the forward counter field by a predefined rule;
forwarding the multimedia message to a third MMSC; treating the third MMSC as the current MMSC;
repeating the steps of analyzing the multimedia message and checking the value of the forward counter field.

4. The method as claimed in claim 1, wherein prior to the current MMSC analyzing said forward counter field further comprising the steps of:
the current MMSC determining whether the recipient user terminal belongs to the same MMSC, if so, the current MMSC delivering the multimedia message directly to the recipient user terminal and exiting the forwarding process;
otherwise, the current MMSC determining if the multimedia message has a forward counter field; if so, the current MMSC analyzing the forward counter field and continuing with the forwarding process; otherwise, the current MMSC adding a forward counter field to the multimedia message and assigning an initial value to the forward counter field.

5. The method as claimed in claim 4, further comprising
forwarding the message to a fourth MMSC;
treating the fourth MMSC as the current MMSC and repeating the steps of analyzing the multimedia message and checking the value of the forward counter field.

6. The method as claimed in claim 1, wherein analyzing the forward counter field further comprising the steps of:
the current MMSC verifying if the value in the forward counter field is invalid;
if so, the current MMSC assigning an initial value to the forward counter field;
otherwise, continuing to check the value of the forward counter field.

7. The method as claimed in claim 1, wherein the multimedia message to be forwarded to the second MMSC is in the MM4 protocol format, where the multimedia message is a forward request message, i.e., MM4_forward.REQ, and a new added field in the forward request message is the forward counter field i.e., MM4_forward_counter.

8. The method as claimed in claim 1, wherein the predefined rule can be in an increasing order, or in a decreasing order or other appropriate manners as long as there is a way to derive the number of times that a multimedia message has been forwarded among several MMSCs.

9. The method as claimed in claim 8, wherein the predefined rule in the increasing order is adapted, the initial value of the forward counter field is assigned to 1; where each time that the multimedia message is forwarded, the forward counter field is incremented by 1, and the current MMSC stops forwarding the multimedia message if the value of the forward counter field reaches the predefined value, which indicates that the number of the message has been forwarded reaching a maximum forwarding limit.

10. The method as claimed in claim 8, wherein the predefined rule in the decreasing order is adapted, the initial value of the forward counter field is assigned to the value of the maximum forwarding limit, where each time that the multimedia message is forwarded, the value of its forward counter field is decremented by 1, and the current MMSC stops forwarding the message if the value of the forward counter field reaches 1.
